(19) United States
(12) Patent Application Publication
(10) Pub. No.: US 2016/0180464 A1
(43) Pub. Date: Jun. 23, 2016

(54) SYSTEM AND METHOD FOR ENABLING ORGANIZATIONS TO OFFERING FINANCING

(71) Applicant: Robert Lataille, Herndon, VA (US)

(72) Inventors: Robert Lataille, Herndon, VA (US); Philip Bothwell, Falls Church, VA (US)

(21) Appl. No.: 14/791,357

(22) Filed: Jul. 3, 2015

Related U.S. Application Data
(60) Provisional application No. 62/020,398, filed on Jul. 3, 2014.

(51) Int. Cl. G06Q 40/06; G06Q 20/10

(52) U.S. Cl. CPC G06Q 40/06; G06Q 20/102

(57) ABSTRACT

A computer-implemented method for enabling organizations to offer financing to a customer is provided. The method comprises a provider computer, upon receipt of approval from an organization, offering a facility for a customer of the organization to execute documentation comprising at least a note promising at least one of a deferred payment and a series of payments to the organization. The method also comprises the provider computer servicing an account of the customer account on behalf of the organization, wherein servicing comprises at least one of invoicing the customer and receiving payments from the customer. The method also comprises the provider computer sending a message to the organization, the message offering the organization an ability to liquidate the funds through reassignment.

### CROSS REFERENCE TO RELATED APPLICATIONS

None.

### FIELD OF THE DISCLOSURE

The present disclosure is in the field of revenue and cash management for organizations. More particularly, the present disclosure is in the technical field of financial management for membership organizations that receive fees and dues from members.

### BACKGROUND OF THE DISCLOSURE

Organizations of many kinds find that the process of extending financing to customers may be prohibitively burdensome. Barriers faced by the organizations may include lack of expertise, costs, lack of continuity of leadership, and illiquidity. These organizations often face costs and expertise requirements associated with assembling complete and proper legal documentation and complying with local, state, and federal regulations. Additionally the costs and labor required to track and service debt and take actions to collect on bad debt are burdensome. For collegiate membership based organizations and other membership based organizations that rely on volunteer, elected, or minimally compensated leaders, continuing changes in leadership present the organizations with difficulty in executing long term initiatives. In addition to these barriers, organizations have additional reservations due to the cash flow uncertainty and illiquidity associated with offering financing that could result in an inability to satisfy near and/or longterm liabilities despite the known advantages this offering could bring to the organization.

A number of advantages exist for organizations able to accept payments in the form of structured debt from their customers. These advantages include increased revenue from interest accrued on outstanding debt notes, the ability to attract additional customers due to financing terms and availability, and reduced price elasticity.

Membership organizations such as collegiate fraternal and sport organizations along with small retailers such as independent dealers of goods such as automobiles and furniture are examples of organizations that can benefit from offering customer financing but can often be overwhelmed by the barriers.

Fraternal organizations including college fraternities and sororities, trade associations, and professional and industry associations charge their members fees or dues for membership. The collected fees often cover membership periods of a year or longer. Members typically pay these charges in one large payment on an annual or even more extended basis, often causing additional sensitivity to the price of membership, resulting in reduced price elasticity. Collegiate membership based organizations are especially burdened by customer sensitivity to the cost of membership. When recruiting new members the ability to pay membership cost are often one of the primary barriers to potential members of these organization. In addition it is not uncommon that members of these collegiate organizations at some point during their time as a member cannot afford to pay their dues and either continue to consume the services of the organization without paying, or forfeit their position as a member of the organization. Additionally in organizations that do not enforce strict payment policies, members who can afford the cost of membership often avoid paying by claiming that they do not have the ability to pay. Organizations often react to their members' and potential members' sensitivity and inability to pay by reducing their pricing to levels that are unmanageable and unsustainable, thus destroying their ability to offer premium services to their members. These collegiate organizations rarely offer financing to members and when they do offer financing, the organizations usually lack the stability to effectively service the debt to maturity, and are restricted by the illiquidity of the debt when they require liquidity to meet current expenses or when determining the services that can be afforded to their members.

While membership organizations often encounter collection problems with members failing to pay charges assessed against them, collegiate organizations face even greater challenges if they wish to offer financing to their members due to the consistent turnover of the organizations' members. The turnover within the organizations make it difficult for these organizations to service debt consistently over an extended period of time. In addition, the limitations of capital and labor resources available to these organizations are especially limiting as these organizations often operate with no cash reserves and no profit. If one of these organizations was able to create and sustain a financing program, the illiquidity associated with term receivables could lead to additional hardships if unplanned expenses emerged.

Collegiate membership organizations such as fraternal organizations often have little continuity in leadership due to the turnover of the membership base and leadership. Collegiate organizations usually fully turn over their active membership base every four to five years. Furthermore the members and leaders of these organizations usually do not offer full time labor services to the organization. This adds to the difficulty of managing an effective collections and servicing program.

By offering financing to their members, collegiate organizations can greatly reduce price elasticity due to the variances in the income of their members during college and after graduation. Providing financing in an environment in which other organizations are not doing so may provide an offering organization with a competitive advantage that can be leveraged by the organization to recruit new members. Financing options provided by the organization to its members allow the recruitment of new members and retention of existing member's regardless of their current socio-economic status. In addition the offering removes the ability of able members to avoid paying dues by claiming a current inability to pay because they are able to satisfy their account through the execution of a structured plan that pushes the cost into the future when the member will most likely have the funds to meet their obligation.

Professional and trade organizations may also have members that are organizations themselves. Such member organizations may be in their infancy at which time their affiliation to trade organizations may be essential and/or highly beneficial but their available budget may be strained due to cost demands of their new business. Enabling trade organizations to easily provide financing to their member organizations may allow the trade organizations to attract more small businesses, increase fees, and increase revenue through the collection of interest while lowering the burden on new businesses. Due to tight margins, in order to offer this type of financing these organizations may require the ability to easily liquidate the debt offered to these organizations to meet business goals or if any unexpected expenses arise.

Membership organizations also suffer price restrictions as well as membership and recruitment challenges arising from collection of dues and other revenue on an annual or more extended basis. Because of tight margins, these organizations may not have adequate working capital to support in-house financing programs. Membership organizations lack the necessary resources to effectively originate and service debt. Thus, a need is presented to overcome these and other challenges associated with the described limitations of annual and more extended billing cycles for membership dues by membership organizations.

While this discussion has largely been directed to membership organizations, vendors of many kinds may be affected by the same problems noted. Independent automobile dealers, dealers of large durable goods such as major appliances as well as furniture, and service based companies such as home remodelers and accountants may also be afflicted with many of these same problems. For startups, small, and medium size businesses competing in a competitive marketplace, the ability to offer customers direct financing is at times a necessity due to standard industry practices as with automotive and furniture dealers. Additionally this ability can create a competitive advantage that attracts customers and allows the company to charge a premium for its products and services. For most startup, small, and medium size companies, financing is not part of their core business and hiring staff to originate, service, and manage customer debt is often cost prohibitive, and counterproductive to their competitiveness against large companies that are able to benefit from economies of scale due to a high volume of accounts. Lastly these businesses due to their size are especially sensitive to reduced cash flow and liquidity that comes along with offering traditional consumer financing.

### SUMMARY OF THE DISCLOSURE

A computer-implemented method for enabling organizations to offer financing to a customer is provided. The method comprises a provider computer, upon receipt of approval from an organization, offering a facility for a customer of the organization to execute documentation comprising at least a note promising at least one of a deferred payment, series of payments, or deferred series of payments to the organization. The method also comprises the provider computer servicing an account of the customer account on behalf of the organization, wherein servicing comprises at least one of invoicing the customer and receiving payments from the customer. The method also comprises the provider computer sending a message to the organization, the message offering the organization an ability to liquidate the funds through reassignment.

A computer-implemented method for enabling organizations to offer financing to a customer is provided. The method comprises a provider computer, upon receipt of agreement from an organization to fund a loan to a customer of the organization from a service provider associated with the provider computer, offering a facility for the customer to execute documentation comprising at least a note promising at least one of a deferred payment and a series of payments to the provider. The method also comprises the provider computer assigning the note to the organization and servicing the account of the customer on behalf of the organization, the servicing comprising at least one of invoicing the customer and receiving payments from the customer. The method also comprises the provider computer sending a message to the organization, the message offering the organization an ability to liquidate the funds through reassignment.

A computer-implemented method for enabling organizations to offer financing to a customer is provided. The method comprises a provider computer, upon receipt of agreement from an organization to fund a loan to a customer of the organization from a partner of a service provider associated with the provider computer, offering a facility for the customer to execute documentation comprising at least a note promising at least one of a deferred payment and a series of payments to the partner. The method also comprises the provider computer transmitting assignment of the note to the organization and servicing an account of the customer behalf of the organization, the servicing comprising of at least one of invoicing the customer and receiving payments from the customer. The method also comprises the provider computer sending a message to the organization, the message offering the organization an ability to liquidate the funds through reassignment.

### BRIEF DESCRIPTION OF THE DRAWINGS

FIG. 1 is an illustration of a block diagram of a system for enabling organizations to offer financing in accordance with an illustrative embodiment of the present disclosure

FIG. 2 is an illustration of a flowchart of a method for enabling organizations to offer financing in accordance with an illustrative embodiment of the present disclosure.

FIG. 3 is an illustration of a flowchart of a method for enabling organizations to offer financing in accordance with an illustrative embodiment of the present disclosure.

FIG. 4 is an illustration of a flowchart of a method for enabling organizations to offer financing in accordance with an illustrative embodiment of the present disclosure.

FIG. 5 is an illustration of a workflow of a method for enabling organizations to offer financing in accordance with an illustrative embodiment of the present disclosure.

### DETAILED DESCRIPTION OF THE INVENTION

The illustrative embodiments provide for origination, servicing, and liquidation of financing for customers of various organizations including membership organizations and independent dealers of goods such as automobiles. The illustrative embodiments provide for an organization to liquidate, if it chooses, its full or partial interest in firm periodic payment arrangements with customers. If the organization is a membership organization, periodic payment arrangements may allow members to pay annual dues, for example, on a monthly or quarterly basis. As periodic payment arrangements may be supported by promissory notes or other negotiable instruments evidencing member obligation, such notes may be assignable for discounting with a funding source with the organization receiving discounted proceeds. A service provider to the organization may continue to collect payments from the member while remitting portions of collected funds to the funding source. In an embodiment, the service provider itself may be the funding source or may locate a funding source for the organization and earn compensation for these services.

Liquidation of firm payment streams backed by promissory notes at the beginning or during the term of periodic payment' arrangements may be beneficial to the cash flow of the organization and can provide liquidity to meet unanticipated cost. In some embodiments, after liquidation of a stream of payments under a periodic payment arrangement, the organization may retain liability for member defaults while in other embodiments the organization may be released from such liability.

Liquidation of member notes may be accomplished in various manners. For example, the service provider may arrange liquidation of a large quantity of member promissory notes from more than one membership organization at a time. Such large scale liquidation may be funded through investment groups assembled by the service provider wherein the investment groups accept assignment of one or many of the promissory notes. The investment groups may thereafter 'securitize the promissory notes and in turn publicly or privately place the securities backed by the notes.

Various methods involving service provider, organization, and customer may be provided. In a basic method, a structured payment plan may be issued to a customer through the organization. In a second and more involved method, a loan may effectively be issued to a customer by the service provider wherein proceeds go the organization. The organization may then transfer its rights under a note in the name of the customer in exchange for full or partial proceeds due to be paid to the organization under the note. In a third and further involved method, a loan is issued to the customer by a partner of the provider agreeing to issue proceeds directly to the organization. As in the second method above, the organization may transfer its rights under a note in the name of the customer in exchange for full or partial proceeds due to be paid to the organization under the note.

The present disclosure more specifically teaches systems and methods of providing organizations including fraternal, professional, trade or other membership organizations various means to enable their members to pay their annual dues or fees under deferred periodic payment arrangements, for example monthly or quarterly. A service provider may be appointed by the membership organization to develop and implement a dues payment structure for organization members that lessens cash flow pressure for both the organization and the members. The service provider and the organization may induce members to pay their dues on a monthly or quarterly basis to promote improved cash flow for the organization, reduces payment defaults, and supports retained membership. The service provider acts on behalf of the organization in managing and enforcing periodic payment arrangements and other agreements between the organization and its member base.

The organization directs the service provider to send documentation to selected members for their execution and return to the service provider. By executing and returning the documentation, members commit to pay their membership dues for an annual or other extended period under a periodic payment arrangement. Such an arrangement requires periodic payments such as monthly or quarterly and is supported by a promissory note or similar instrument. The terms under these notes may include a deferment period to move the payments in to the future. The service provider receives the payments from the members, retains a portion of each as a processing fee, and remits the balance to the organization on a periodic basis.

The methods and systems provided herein may promote the organization to recruit and retain a larger membership by providing, for example, deferred payment terms. Such terms may move the cost of membership into the future when the income of the member is anticipated to be greater, relieving the member from having to make a single lump sum payment to the organization at a time when their income may be very limited. The service provider relieves the organization of the management burden of collecting dues from such members as well as handling record keeping and cash management duties, and provides liquidity for this debt.

The methods and systems provided herein may promote the organization to retain a larger membership by providing, for example, monthly payment terms. Such terms may less onerous for a member than making a single annual lump sum payment to the organization. The service provider relieves the organization of the management burden of collecting dues from such members as well as handling record keeping and cash management duties, and provides liquidity for this debt.

The service provider may not be a party to documentation supporting a periodic payment arrangement and the service provider may not be a party to any underlying membership agreement between the organization and member. The service provider rather acts on behalf of the organization to handle the tasks described herein including sending out and processing executed member documentation, setting up, invoicing, and collecting member accounts, and remitting collected funds to the organization. The service provider may not perform checks of members to determine their worthiness to be offered payment arrangement terms. The service provider may not bear risk of payment default by members.

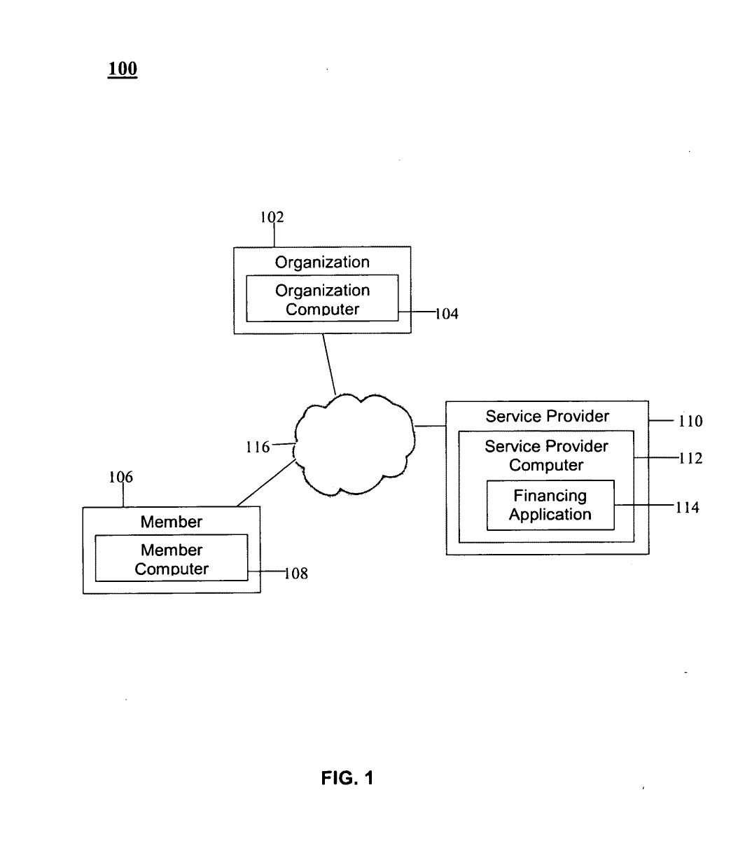

Turning to the figures, FIG. 1 is a block diagram of a system for managing cash flow for membership and other organizations in accordance with an illustrative embodiment of the present disclosure. FIG. 1 depicts a system 100. System 100 comprises at least an organization 102, an organization computer 104, a member 106, a member computer 108, a service provider 110, a service provider computer 112, a financing application 114, and a network 116. The organization computer 104, the member computer 108, the service provider computer 112, and the partner computer 118 may be general purpose computers. General purpose computers are described in detail hereafter.

While not depicted in FIG. 1, it is understood that the system 100 also includes at least one partner and partner computer. The partner is an entity that works with service provider 110 in providing discounting and liquidation services for notes held by the organization 102. The partner uses the at least one partner computer in providing these services.

The financing application 114 executes on the service provider computer 112 and implements the methods provided herein. The service provider computer 112 may in embodiments be a plurality of computers located at more than one site. The financing application 114 may be more than one application with some portions executing on geographically distributed devices, for example in the cloud.

The organization 102 may be a fraternal organization such as a fraternity or sorority with chapters associated with universities and colleges. The organization 102 could also be an individual chapter of a fraternal organization or could also be another collegiate membership organization. The organization 102 may be a professional or trade group or society with members devoted to a common profession or trade. The organization 102 may be a social organization with members devoted to a social pursuit or common cause. The organization 102 may in an embodiment not be a membership organization and may instead be a commercial enterprise such as an independent dealer of automobiles.

The member 106 is a member of the organization 102. In an embodiment the organization may have hundreds or thousands of members worldwide. The member 106 may be a human being or may be a legal entity such as a partnership or corporation. While only one member 106 is depicted in FIG. 1 and provided by system 100, it is understood that a plurality of members represented by member 106 are provided. In an embodiment, the member 106 may not be a member of the organization 102 but may instead be a customer of a commercial enterprise.

The service provider 110 is an entity that provides services associated with the systems and methods provided herein via the service provider computer 112 and the financing application 114. Many actions described herein as taken by the service provider 110 in connection with the systems and methods provided herein are implemented by the service provider computer 112 and the financing application 114.

The service provider 110 offers a plurality of services to entities such as the organization 102. The service provider 110 offers an online system associated with the financing application 114 that provides organizational management services including member billing, collections, account tracking, communication, and legal documents. The financing application 114 allows the member 106 using at least member computer 108 to view information about their account with the organization 102. Such information may include statements, membership status, messages, and other information that the organization 102 and the service provider 110 may determine should be made available for member viewing. The financing application 114 allows member 106 to make payments to the organization 102 or to the service provider 110 via online payment method, via check, via bank draft and via other means. The financing application 114 may be provided as a component of a web-based management platform executing at least in part on the service provider computer 112.

The service provider 110 provides the organization 102 various means to offer members 106 in-house financing by the organization. Such financing is completed through at least three functions provided by the service provider 110: origination, servicing, and liquidation.

### Origination

During origination and afterward, financing decisions to extend credit to the member 106 such that dues for a membership period, for example a year, may be paid in the future on a monthly or quarterly basis are made by the, the organization 102 would bear risk of payment or other default by member 106 and the organization 102 would therefore make organization 102. Since in an embodiment the service provider 110 is not advancing funds up front to the organization decisions whether to offer monthly, quarterly, or other payment options such as deferred to the member 106. The organization 102 agrees that prior to associating with a given member 106 in the system of service provider 110, the organization has validated the worthiness of member 106 to participate wherein participations includes but is not limited to paying dues and fees on a monthly or other basis. In an embodiment, service provider 110 may not as a standard practice perform credit checks or other validation of member 106. In an embodiment, service provider may perform credit checks or other validation for a fee or prior to liquidation.

The organization 102 as originator of agreements with its members 106 retains the authority to set any terms of the agreements. The organization 102 may bear legal obligation to ensure that terms of its agreements are in compliance with local, state and federal laws. The service provider 110 may provide guidance to the organization 102 as to what legal terms apply in a given situation with members 106. The service provider 110 may implement controls to provide warnings or bar the organization 102 from setting terms of agreements with members 106 that may not be in compliance with laws and regulations.

The systems and methods provided herein facilitate execution of documents associated with the organization 102 providing membership services to its members 106. Such documents may include membership agreement between the organization 102 and member 106 or membership agreement between the organization 102, the member 106, and a cosigner whose support of a debt note may be necessary, for example in the case of a college student that may be a legal minor. The documents may also include a debt note or promissory note executed by the member 106 in favor of the organization 102 that evidences an obligation by the member 106 to pay membership dues or fees on a monthly or quarterly, for example, basis.

### Execution and Servicing

The systems and methods also facilitate execution of such documents as organizational agreements between the organization 102 and service provider 110. Such documents may also include reasignment agreements between the organization 102 and service provider 110 or other liquidating party providing terms and conditions under which wherein the service provider 110 agrees to assist in liquidation of notes executed by members 106. The reasignment agreement is an instrument by which the organization 102 will liquidate their debt. The service provider 110 may accept signed documents from the organization 102, from members 106, and from other parties by U.S. Mail, via facsimile transmission, and by personal delivery. The organization or its assignees may accept payments from members submitted online.

In an embodiment, the service provider 110 may retain copies of executed promissory notes received from members 106 on behalf of the organization 102. In other embodiments, the service provider 110 may not retain documents and may instead store only information about agreements between at least the service provider 110 and members 106. Such documents may include agreements between the service provider 110 and the organization 102.

The service provider 110 also performs record keeping tasks associated with payments billed and received under promissory note arrangements between the organization 102 and members 106. The service provider 110 also maintains accounts of collective values of promissory notes on the books of organization 102.

The service provider 110 invoices members 106 under their promissory note obligations. Members 106 send payments to service provider 110 using the methods described.

The service provider 110 may process payments and receive compensation for its services in a plurality of manners. In an embodiment, the service provider 110 may apply liens against promissory notes for which the service provider 110 is billing, collecting, and otherwise servicing. The service provider 110 accrues interest on the liens based on interest rates in the promissory notes. When the member 106 sends a payment to service provider 110, a portion of the payment is applied to pay off the promissory note of the member 106 and a portion is applied to pay off the lien. The portion applied to pay off the lien is retained by the service provider 110 as compensation for its services to the organization 102. If a promissory note is defaulted upon by the member 106, the lien against the defaulted promissory note transfers to other promissory notes held by the organization and serviced by the service provider. If no other notes exist, the organization 102 would then have a negative account balance with the service provider 110 and may be invoiced by the service provider 110.

The service provider 110, instead of applying liens as discussed above, may instead charge the organization 102 up front for origination fees or service charges or may charge the organization 102 for services as the services are provided by the service provider 110. In another embodiment, the service provider 110 charges a flat rate to the organization per year or other time period for providing services described herein. In another embodiment involving pay for use/utilization, fees may be assessed against the organization at the end of a period for services performed during the period.

### Liquidation

The systems and methods provided herein enable the service provider 110 provide for liquidation of debt notes executed by members 106. The organization 102 may benefit from discounting streams of payments owed the organization 102 under debt notes. The service provider 110 may provide the organization 102 an ability to place debt notes for sale. However, in an embodiment, the service provider 110 may not guaranty to the organization that the debt notes will be liquidated at a price at which the organization 102 posts the debt notes for sale. The service provider 110 may instead provide the organization a suggested price at which the debt notes may be posted for sale. In another embodiment, the service provider may provide instant guaranteed liquidation of debt notes at an agreed price.

The service provider 110 may in an embodiment establish a fund to purchase debt notes from the organization 102. The service provider 110 may in an embodiment partner with a third party company to liquidate debt notes. In an embodiment, the fund may be a collection of organizations 102 that are parties to many notes such as those described herein. This may provide a more diversified and high yield investment. The service provider 110 may pass on some of the costs incurred by the third party company on to the organization 102,

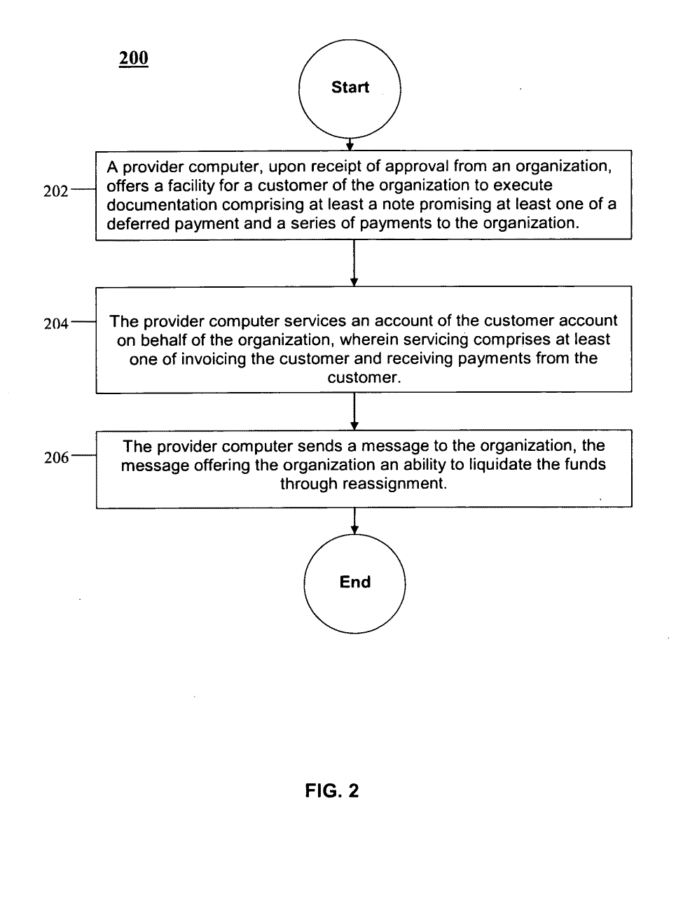

FIG. 2 is an illustration of a flowchart of a method for enabling organizations to offer financing in accordance with an illustrative embodiment of the present disclosure. FIG. 2 illustrates a method 200 wherein components of the method 200 are provided by system 100 provided herein.

Beginning at block 202, a provider computer, upon receipt of approval from an organization, offers a facility for a customer of the organization to execute documentation comprising at least a note promising at least one of a deferred payment and a series of payments to the organization. At block 204, the provider computer services an account of the customer account on behalf of the organization, wherein servicing comprises at least one of invoicing the customer and receiving payments from the customer. At block 206, the provider computer sends a message to the organization, the message offering the organization an ability to liquidate the funds through reassignment. Method 200 terminates thereafter.

In method 200, a structured payment plan issued to the customer through the organization. A series of payments or a single deferred payment for the customer may be arranged.

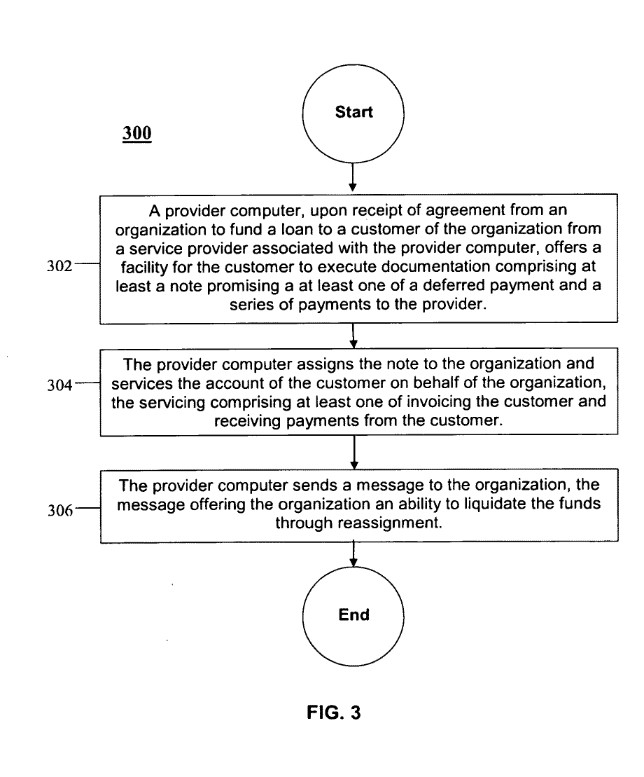

FIG. 3 is an illustration of a flowchart of a method for enabling organizations to offer financing in accordance with an illustrative embodiment of the present disclosure. FIG. 3 illustrates a method 300 wherein components of the method 300 are provided by system 100 provided herein.

Beginning at black 302, a provider computer, upon receipt of agreement from an organization to fund a loan to a customer of the organization from a service provider associated with the provider computer, offers a facility for the customer to execute documentation comprising at least a note promising a at least one of a deferred payment and a series of payments to the provider. At block 304, the provider computer assigns the note to the organization and services the account of The customer on behalf of the organization, the servicing comprising at least one of invoicing the customer and receiving payments from the customer. At block 306, the provider computer sends a message to the organization, the message offering the organization an ability to liquidate the funds through reassignment. Method 300 terminates thereafter.

In the method 300, a loan is effectively issued by the service provider to a customer wherein proceeds go the organization. The organization transfers its rights under a note in the name of the customer in exchange for proceeds due to be paid to the organization under the note. The organization 102 is provided a channel by which it can liquidate its debt notes. While this is an option to the organization 102 that the organization 102 may initiate, in an embodiment the service provider 110 may contact the organization 102 offering to liquidate debt notes of the organization 102.

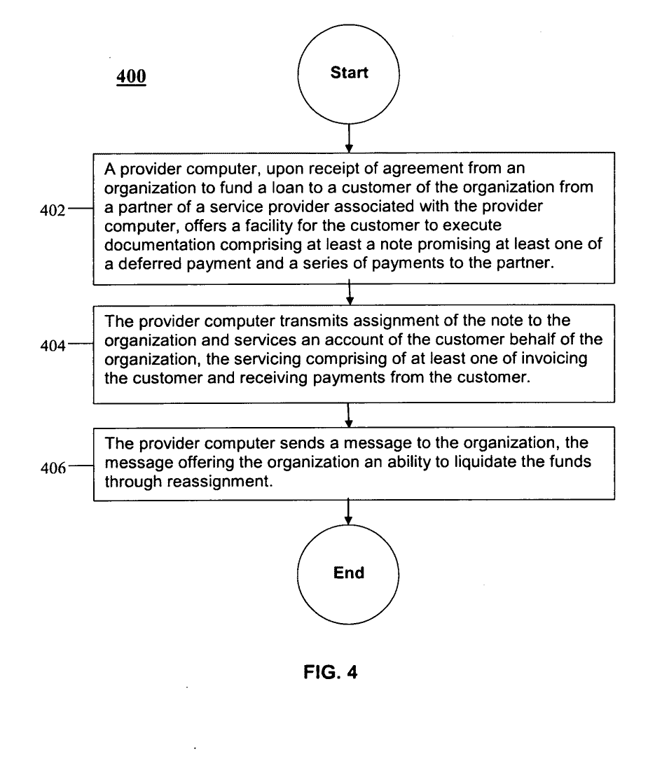

FIG. 4 is an illustration of a flowchart of a method for enabling organizations to offer financing in accordance with an illustrative embodiment of the present disclosure. FIG. 4 illustrates a method 400 wherein components of the method 400 are provided by system 100 provided herein.

Beginning at block 402, a provider computer, upon receipt of agreement from an organization to fund a loan to a customer of the organization from a partner of a service provider associated with the provider computer, offers a facility for the customer to execute documentation comprising at least a note promising at least one of a deferred payment and a series of payments to the partner. At block 404, the provider computer transmits assignment of the note to the organization and services an account of the customer behalf of the organization, the servicing comprising of at least one of invoicing the customer and receiving payments from the customer. At block 406, the provider computer sends a message to the organization, the message offering the organization an ability to liquidate the funds through reassignment. Method 400 terminates thereafter.

In the method 400, a partner of the provider issues a loan with proceeds going directly to the organization. As in the method 300, the organization transfers its rights under a note in the name of the customer in exchange for proceeds due to be paid to the organization under the note. The note at origination will promise payments to the partner. The partner is then assigning the note to the organization in exchange for the funding provided by the organization. When the organization 102 goes to liquidate the note the organization 102 will then liquidate the note by reassigning the rights under the note that they were assigned.

Method 200, method 300, and method 400 provide three different non-limiting manners in which debt notes from customers may be liquidated. Other methods may be implemented using the components of system 100. The methods 200, 300, and 400 utilize the same method of liquidation wherein the organization reassigns their rights in exchange for a discounted value or full value.

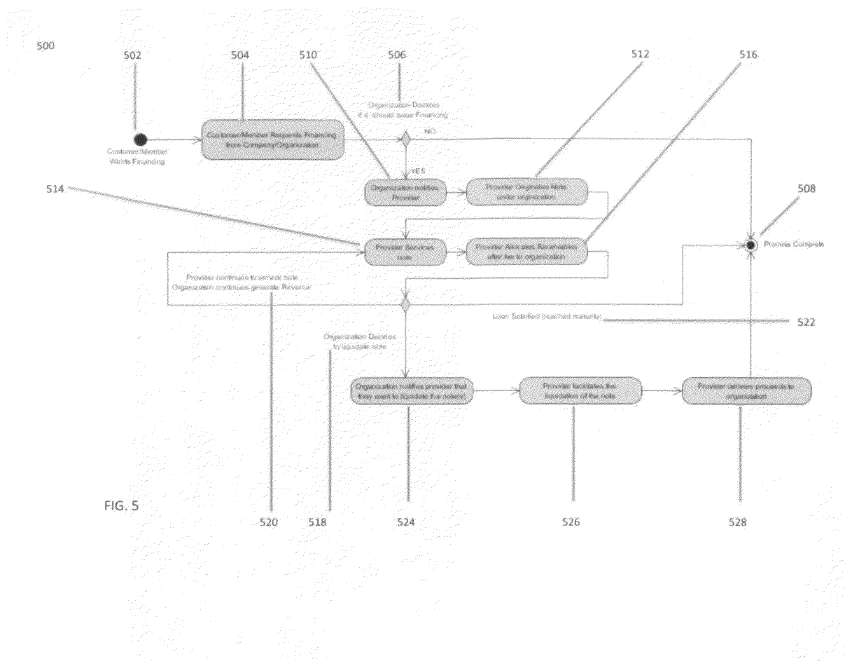

FIG. 5 is a diagram of a workflow for enabling organizations to offer financing in accordance with an illustrative embodiment of the present disclosure. FIG. 5 illustrates a workflow 500 wherein components of the workflow 500 are provided by system 100 provided herein.

Workflow 500 begins when customer/member wants financing 502. Workflow 500 continues when customer/member requests financing from company/organization 504. Organization then decides if it should issue financing 506. If not, the process of workflow 500 completes at 508. If yes, organization notifies provider 510 and provider originates note under organization 512. Thereafter provider services note 514 and provider allocates receivables after fee to organization 516. Thereafter, at least one of three actions may take place. Organization may decide to liquidate note 518. Alternatively, provider continues to service note and organization continues to generate revenue 520 wherein workflow 500 then proceeds or loops back to provider services note 514 and workflow 500 continues from there. Alternatively, loan may be satisfied (reached maturity) 522 after which method 500 proceeds to process complete 508.

If organization decides to liquidate note 518, the next step of workflow 500 is organization notifies provider that that want to liquidate the note(s) 524. Thereafter, provider facilitates the liquidation of the note 526. Thereafter, provider delivers proceeds to the organization 528, and thereafter the process completes 508.

As noted, the organization computer 104, the member computer 108, and the service provider computer 112 are general purpose computers. A general purpose computer comprises at least one processor or central processing unit (CPU), read-only memory, random access memory, data storage, and input/output devices. The general purpose computer may also comprise network interface cards (NIC) to communicate on a local area network (LAN) and other hardware promoting communication over wide area networks and the Internet. Data storage could be in memory in RAM and no hard drive could exist in any of the computers.

Although the above descriptions set forth preferred embodiments, it will be understood that there is no intent to limit the embodiment of the disclosure by such disclosure, but rather, it is intended to cover all modifications, substitutions, and alternate implementations falling within the spirit and scope of the embodiment of the disclosure. The embodiments are intended to cover capabilities and concepts whether they be via a loosely coupled set of components or they be converged into one or more integrated components, devices, circuits, and/or software programs.

1. A computer-implemented method for enabling organizations to offer financing to a customer, comprising:
a provider computer, upon receipt of approval from an organization, offering a facility for a customer of the organization to execute documentation comprising at least a note promising at least one of a deferred payment and a series of payments to the organization;
the provider computer servicing an account of the customer account on behalf of the organization, wherein servicing comprises at least one of invoicing the customer and receiving payments from the customer;
the provider computer sending a message to the organization, the message offering the organization an ability to liquidate the funds through reassignment.

2. The computer-implemented method of claim 1, wherein the organization is a membership based organization and the customer is a member of the organization,
wherein the organization can create and manage associations between the organization and a plurality of customers,
wherein the organization creates and assesses charges, fees, and credits with the plurality of customers.
wherein the plurality of customers are provided means to view account information including statements, membership status, messages, and other information deemed appropriate for customer viewing by the organization and the service provider.
wherein the organization pre-approves the plurality of customers to execute notes to satisfy the account balances of the customers, and
wherein the organization and the customers further execute documents including agreements verifying the association of the customers with the organization and the charges assessed by the organization.

3. The computer-implemented method of claim 1, wherein the provider computer forwards payments received from the customer to the organization with separate billing to the organization for services rendered, and wherein the provider alternately assigns a lien against the notes for services rendered with a portion of the payments being applied to the providers lien as compensation for services rendered and the remainder being forwarded to the organization.

4. The computer-implemented method of claim 1, wherein the provider computer is associated with a service provider that bills member accounts, collects payments owed under the account, tracks member accounts, provides communication, and develops and furnishes legal documents where necessary,
wherein the provider computer offers the organization the ability to manage the bills and accounts of customers through an internet site established associated with the provider computer, and
wherein the provider computer offers the organization the ability to collect funds as the funds become due from customers through the internet site.

5. The computer-implemented method of claim 2, wherein the note enables the member to pay fees for membership to the organization in one of weekly, biweekly, monthly, quarterly, annual, or balloon payments, and wherein the member makes periodic payments under the note to the service provider by at least one of check, online payment, and automatic bank debit.

6. The computer-implemented method of claim 1, further comprising the provider computer, based on initiating action taken by at least one of the provider and the organization, facilitating the organization liquidating its rights under the note by at least one of:
the organization assigning the rights and a stream of payments in return for discounted proceeds,
the provider itself funding the liquidation
the provider involving a third party, and
the provider involving a pool of investors to provide the funds to facilitate the organization liquidating the rights of the organization.

7. A computer-implemented method for enabling organizations to offer financing to a customer, comprising:
a provider computer, upon receipt of agreement from an organization to fund a loan to a customer of the organization from a service provider associated with the provider computer, offering a facility for the customer to execute documentation comprising at least a note promising a at least one of a deferred payment and a series of payments to the provider,
the provider computer assigning the note to the organization and servicing the account of the customer on behalf of the organization, the servicing comprising at least one of invoicing the customer and receiving payments from the customer; and
the provider computer sending a message to the organization, the message offering the organization an ability to liquidate the funds through reassignment.

8. The computer-implemented method of claim 7, wherein the organization is a membership-based organization and the customer is a member of the organization,
wherein the organization can create and manage associations between the organization and a plurality of customers,
wherein the organization creates and assesses charges, fees, and credits with the plurality of customers.
wherein the plurality of customers are provided means to view account information including statements, membership status, messages, and other information deemed appropriate for customer viewing by the organization and the service provider.
wherein the organization pre-approves the plurality of customers to execute notes to satisfy the account balances of the customers, and
wherein the organization and the customers further execute documents including agreements verifying the association of the customers with the organization and the charges assessed by the organization.

9. The computer-implemented method of claim 7, wherein the provider computer forwards payments received from the customer to the organization with separate billing to the organization for services rendered, and wherein the provider alternately assigns a lien against the notes for services rendered with a portion of the payments being applied to the providers lien as compensation for services rendered and the remainder being forwarded to the organization.

10. The computer-implemented method of claim 8, wherein the provider computer is associated with a service provider that bills member accounts, collects payments owed under the account, tracks member accounts, provides communication, and develops and furnishes legal documents where necessary,
wherein the provider computer offers the organization the ability to manage the bills and accounts of customers through an internet site established associated with the provider computer, and
wherein the provider computer offers the organization the ability to collect funds as the funds become due from customers through the internet site.

11. The computer-implemented method of claim 8, wherein the note enables the member to pay fees for membership to the organization in one of weekly, biweekly, monthly, quarterly, annual, or balloon payments, and wherein the member makes periodic payments under the note to the service provider by at least one of check, online payment, and automatic bank debit.

12. The computer-implemented method of claim 7, further comprising the provider computer facilitating the organization liquidating its rights under the note by at least one of:
the organization assigning the rights and a stream of payments in return for discounted proceeds,
the service provider itself funding the liquidation
the service provider involving a third party, and
the service provider involving a pool of investors to provide the funds to facilitate the organization liquidating the rights of the organization.

13. The computer-implemented method of claim 20, wherein the organization funds the loan by at least one of transferring funds directly to the provider computer and the loan through debt assigned to the service provider.

14. A computer-implemented method for enabling organizations to offer financing to a customer, comprising:
a provider computer, upon receipt of agreement from an organization to fund a loan to a customer of the organization from a partner of a service provider associated with the provider computer, offering a facility for the customer to execute documentation comprising at least a note promising at least one of a deferred payment and a series of payments to the partner,
the provider computer transmitting assignment of the note to the organization and servicing an account of the customer behalf of the organization, the servicing comprising of at least one of invoicing the customer and receiving payments from the customer;
the provider computer sending a message to the organization, the message offering the organization an ability to liquidate the funds through reassignment.

15. The computer-implemented method of claim 14, wherein the organization is a membership based organization and the customer is a member of the organization,
wherein the organization can create and manage associations between the organization and a plurality of customers,
wherein the organization creates and assesses charges, fees, and credits with the plurality of customers.
wherein the plurality of customers are provided means to view account information including statements, membership status, messages, and other information deemed appropriate for customer viewing by the organization and the service provider.
wherein the organization pre-approves the plurality of customers to execute notes to satisfy the account balances of the customers, and
wherein the organization and the customers further execute documents including agreements verifying the association of the customers with the organization and the charges assessed by the organization.

16. The computer-implemented method of claim 14, wherein the provider computer forwards payments received from the customer to the organization with separate billing to the organization for services rendered, and wherein the provider alternately assigns a lien against the notes for services rendered with a portion of the payments being applied to the providers lien as compensation for services rendered and the remainder being forwarded to the organization.

17. The computer-implemented method of claim 14, wherein the provider computer is associated with a service provider that bills member accounts, collects payments owed under the account, tracks member accounts, provides communication, and develops and furnishes legal documents where necessary,
wherein the provider computer offers the organization the ability to manage the bills and accounts of customers through an internet site established associated with the provider computer, and
wherein the provider computer offers the organization the ability to collect funds as the funds become due from customers through the internet site.

18. The computer-implemented method of claim 15, wherein the note enables the member to pay fees for membership to the organization in one of weekly, biweekly, monthly, quarterly, annual, or balloon payments, and wherein the member makes periodic payments under the note to the service provider by at least one of check, online payment, and automatic bank debit.

19. The computer-implemented method of claim 14, further comprising the provider computer facilitating the organization liquidating its rights under the note by at least one of:
the organization assigning the rights and a stream of payments in return for discounted proceeds,
the provider itself funding the liquidation
the provider involving a third party, and
the provider involving a pool of investors to provide the funds to facilitate the organization liquidating the rights of the organization.

20. The method of claim 14, wherein the organization funds the loan by at least one of:
transferring funds directly to the service provider,
through debt assigned to the service provider.
through debt assigned to the partner of the service provider.
by transferring funds directly to the partner of the service provider,
wherein the partner of the service provider is a financial institution.
